(19) United States
(12) Patent Application Publication
(10) Pub. No.: US 2013/0162792 A1
(43) Pub. Date: Jun. 27, 2013

(54) NOTIFYING SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/534,052

(22) Filed: Jun. 27, 2012

(30) Foreign Application Priority Data
Dec. 27, 2011 (TW) 100148744

(51) Int. Cl. H04N 7/18

(52) U.S. Cl. 348/77; 348/E07.085

(57) ABSTRACT

A notifying method includes: capturing images around a taxi through at least one camera; detecting the images obtained by the camera to find out whether there are persons in the images; comparing the person in the image with images stored in a storing module when there is a person in the image captured by the camera; outputting a first signal when the person in the image obtain by the camera is the same as one of the images stored in the storing module; outputting a second signal to a notifying unit; and notifying a driver of the taxi that there is a passenger around the taxi through the notifying unit.

### BACKGROUND

1. Technical Field

The present disclosure relates to a system and a method for notifying taxi drivers whether there is a passenger.

2.Description of Related Art

Taxi drivers need to look around the taxi to find out whether there is a passenger who wants to take the taxi. This is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a car equipped with a notifying system.

FIG. 2 is a block diagram of the notifying system of FIG. 1.

FIG. 3 is a flowchart of an exemplary embodiment of a notifying method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

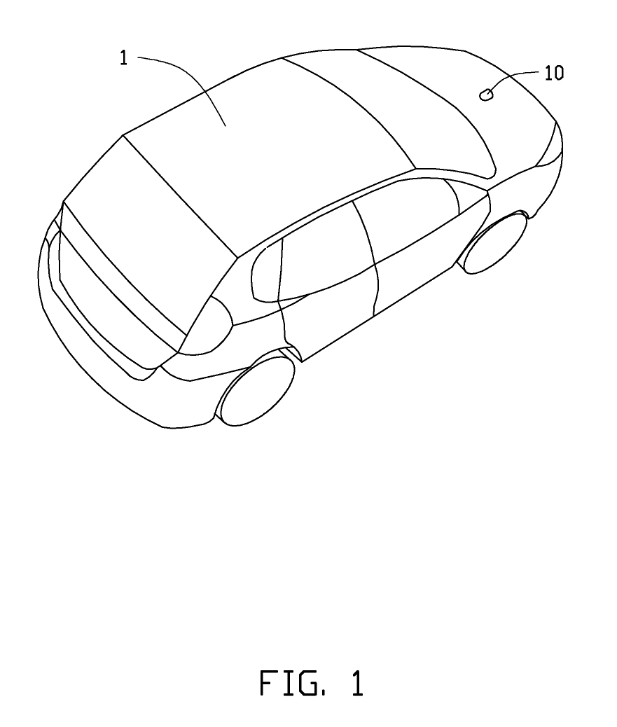

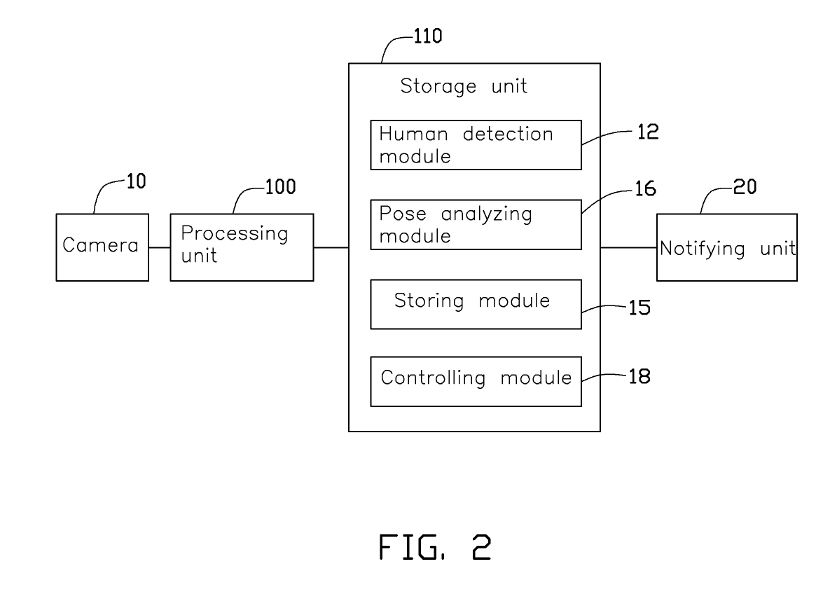

Referring to FIG. 1 and FIG. 2, an exemplary embodiment of a notifying system includes a camera 10, a processing unit 100, a storage unit 110, and a notifying unit 20.

The storage unit 110 includes a human detection module 12, a storing module 15, a pose analyzing module 16, and a controlling module 18. The human detection module 12, the pose analyzing module 16, and the controlling module 18 may include computer codes to be executed by the processing unit 100.

The camera 10 is mounted on the outside of a taxi 1 for capturing images around the taxi 1. The human detection module 12 detects the images obtained by the camera 10 to find out whether there are persons in the images. The storing module 15 stores a plurality of images. The images stored in the storing module 15 include an image of a person with different poses which stand for wanting to take a taxi, such as beckoning. The plurality of different images can be obtained in advance. In other embodiments, the notifying system can include two or more cameras. The other camera is mounted on the back of the taxi 1.

When the human detection module 12 determines that there is a person in the image captured by the camera 10, the pose analyzing module 16 compares the person in the image with the images stored in the storing module 15. If the person in the image obtain by the camera 10 is same as one of the images stored in the storing module 15, the pose analyzing module 16 determines that there is a passenger who wants to take the taxi 1. If the person in the image obtain by the camera 10 is different from all images stored in the storing module 15, the pose analyzing module 16 determines that the person in the image is not a potential passenger who wants to take the taxi 1.

When the pose analyzing module 16 determines that there is a passenger who wants to take the taxi 1, the pose analyzing module 16 outputs a first signal to the controlling module 18. The controlling module 18 outputs a second signal to the notifying unit 20. The notifying unit 20 notifies the driver that there is a passenger around the taxi 1.

In the embodiment, the notifying unit 20 can notify the driver by sound or words.

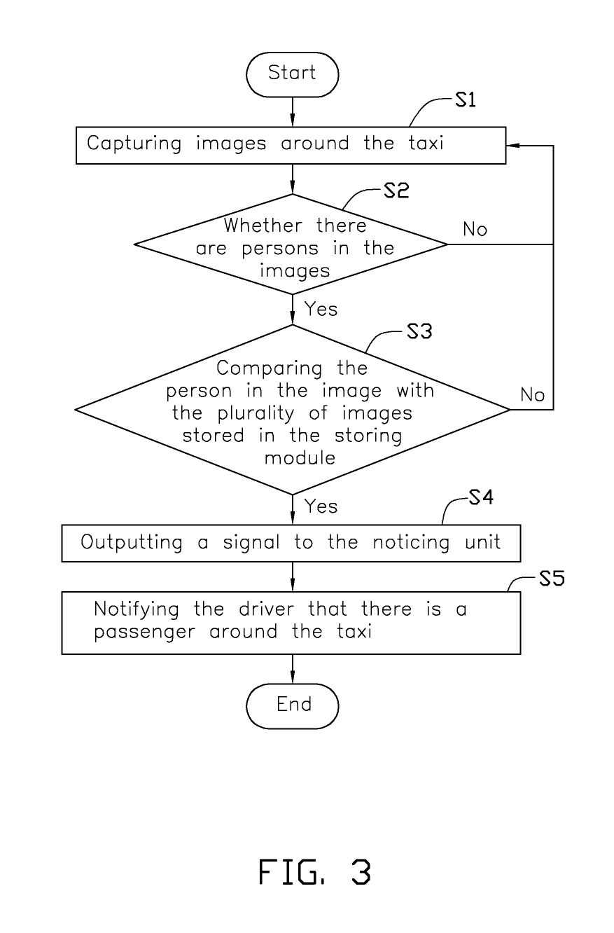

Referring to FIG. 3, an exemplary embodiment of a notifying method includes the following steps.

In step S1, the camera 10 captures images around the taxi 1. The camera 10 is mounted on the body of the taxi 1.

In step S2, the human detection module 12 detects the images obtained by the camera 10 to find out whether there are persons in the images. When the human detection module 12 determines that there is a person in the image captured by the camera 10, the procedure flows to step S3. When the human detection module 12 determines that there is no person in the image captured by the camera 10, the procedure returns to step S1.

In step S3, the pose analyzing module 16 compares the person in the image with the plurality of images stored in the storing module 15. If the person in the image obtain by the camera 10 is same as one of the images stored in the storing module 15, the procedure flows to step S4. If the person in the image obtain by the camera 10 is different from all images stored in the storing module 15, the procedure returns to step S1.

In step S4, the pose analyzing module 16 outputs a first signal to the controlling module 18, and the controlling module 18 outputs a second signal to the notifying unit 20.

In step S5, the notifying unit 20 notifies the driver that there is a passenger around the taxi 1. In this embodiment, the notifying unit 20 can notify the driver by sound or words.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A notifying system, comprising:
at least one camera mounted on a taxi to capture an image around the taxi;
a processing unit connected to the camera;
a storage unit connected to the processing unit and storing a plurality of programs to be executed by the processing unit, wherein the storage unit comprises:
a human detection module to detect the image obtained by the camera to find out whether there is a person in the image;
a storing module storing a plurality of images showing a person with different gestures when hailing a taxi;
a pose analyzing module to compare the person in the image with the plurality of images stored in the storing module when the human detection module determines that there is a person in the image obtained by the camera, wherein when the person in the image obtain by the camera is the same as one of the images stored in the storing module, the pose analyzing module outputs a first signal; and
a controlling module to output a second signal in response to receipt of the first signal; and
a notifying unit to notify a driver of the taxi that there is a passenger around the taxi in response to receipt of the second signal.

2. The system of claim 1, wherein the images stored in the storing module comprises a person beckoning.

3. The system of claim 1, wherein the notifying unit notifies the driver through sounds or words.

4. A notifying method, comprising:
capturing an image around a taxi through at least one camera, wherein the camera is mounted on the taxi;
detecting the image obtained by the camera to find out whether there are persons in the image;
comparing the persons in the image with a plurality of images stored in a storing module when there is a person in the image captured by the camera;
outputting a first signal when the person in the image obtain by the camera is same as one of the images stored in the storing module;
outputting a second signal to a notifying unit; and
notifying a driver of the taxi that there is a passenger around the taxi through the notifying unit.

5. The method of claim 4, wherein the images stored in the storing module comprises a person beckoning.

6. The method of claim 4, wherein the notifying unit notifies the driver through sounds or words.
